(19) United States
(12) Patent Application Publication
(10) Pub. No.: US 2016/0013590 A1
(43) Pub. Date: Jan. 14, 2016

(54) CORD LOCK

(71) Applicant: Joe Williams, Gonne Terre, MO (US)

(72) Inventor: Joe Williams, Gonne Terre, MO (US)

(21) Appl. No.: 14/325,638

(22) Filed: Jul. 8, 2014

(51) Int. Cl. H01R 13/639; H01R 13/622

(52) U.S. Cl. CPC H01R 13/6392; H01R 13/622

(57) ABSTRACT

A cord lock comprising a housing, where the housing is fastened snugly around a plug of a first extension cord and a socket of a second extension cord; a first portion of the housing, where the first portion includes a neck; and a second portion of the housing, where the second portion includes a receiving portion to accept the neck of the first portion. The neck and receiving portions may be threaded to enable the first portion to screw into the second portion to secure the housing together.

### BACKGROUND OF THE INVENTION

1. Field of the Invention

The present invention relates to a cover and lock to secure two connection points on a cord together.

2. Description of Related Art

Many people use extension cords on a daily basis to power devices that may have a cord too short to reach a wall outlet. The extension cords may be used in an office building to activate a printer, at home to illuminate a lamp or on a construction site to power a saw. Whatever the reason, extension cords are very useful by providing electricity to greater distances from the outlet than the attached electrical cord.

A problem encountered, especially on a construction site, is that with all the movement around the site the cords' plugs and sockets often get tugged and/or separated cutting off electricity to a necessary tool. When this occurs the worker must stop what they're doing, find the connection ends, and rejoin the cords before resuming their work. This is typically tedious and annoying for the worker. Some people resort to tying the extension cord in a knot at the joint of the plug and socket so that if either cord is pulled the knot is simply tightened rather than separating the union. The problem associated with this solution is that the cords often become worn or even frayed at the knot bends resulting in permanent damage to the cord or a potential electrocution risk to the user.

Therefore it would be beneficial in the art to provide a device that prevents the plugs and sockets of extension cords from detaching from one another. It would also be desirable in the art to provide a device that is easy to use yet durable enough for environments like a construction site.

### SUMMARY OF THE INVENTION

In view of the foregoing disadvantages inherent in the prior art, the general purpose of the present invention is to provide a cord lock to secure the plug and socket of an extension cord, configured to include all of the advantages of the prior art, and to overcome the drawbacks inherent therein.

Accordingly, an object of the present invention is to provide a cord lock including a two portioned housing that fastens around the plug and socket of an extension cord to prevent the pieces from separating if/when the cord is tugged.

To achieve the above objects, in an aspect of the present invention, a cord lock is described comprising a housing, where the housing is fastened snugly around a plug of a first extension cord and a socket of a second extension cord; a first portion of the housing, where the first portion includes a neck; and a second portion of the housing, where the second portion includes a receiving portion to accept the neck of the first portion. The neck and receiving portions may be threaded to enable the first portion to screw into the second portion to secure the housing together.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a cord lock in accordance with an exemplary embodiment of the present invention; and

FIG. 2 depicts a perspective view of a cord lock in a closed position in accordance with an exemplary embodiment of the present invention.

FIG. 3 depicts a perspective view of a cord lock in a closed position in accordance with an second exemplary embodiment of the present invention.

FIG. 4 depicts a sectional view of the cord lock housing shown in FIG. 3.

Like reference numerals refer to like parts throughout the description of several views of the drawings.

### DETAILED DESCRIPTION OF THE DRAWINGS

The present invention relates to a cover and lock to secure two connection points on a cord together. The present invention provides a cord lock to help keep power cords connected to one another. The cord lock includes two portions which are threaded together over the cord plugs. The cord lock encloses the connection point between two extension cords, thereby preventing the two cords from pulling apart even after a hefty tug. This way the user does not have to resort to knotting the cord to ensure the junction remains together, which typically results in damage to the cord and plugs.

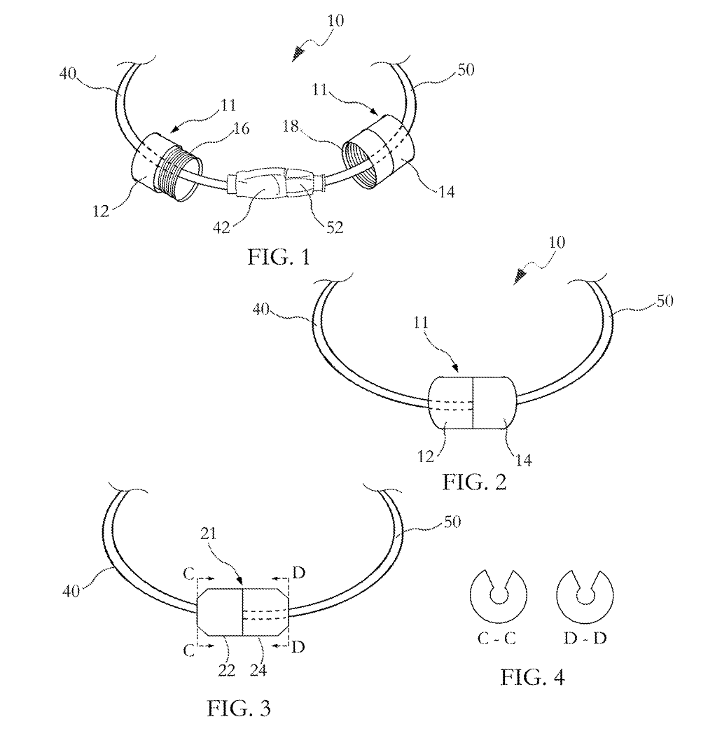

Turning now descriptively to the drawings, FIG. 1 illustrates a cord lock 10 in accordance with an exemplary embodiment of the present invention. The cord lock 10 includes a housing 11 which envelops a plug 52 and an adjoining socket 42 of a pair of extension cords 40, 50. The housing 11 comprises a cylindrical shape around the plug 52 and socket 42. The housing 11 is split into two parts, a first portion 12 and a second portion 14. The first portion 12 includes a neck 16 which is received by a receiving portion 18 within the second portion 14. The neck 16 and the receiving portion 18 may be threaded to screw the two portions together thereby securely closing the housing 11. Alternatively, the neck 16 may include a single thread that is snapped into a single thread within the receiving portion 18. The housing 11 may be made from a durable plastic able to withstand substantial tugging without separating.

Referring now to FIG. 2 a perspective view of the cord lock 10 is shown in a closed position. The first portion 12 and the second portion 14 of the housing 11 connect to each other to completely enclose the plug and socket. Each portion of the housing 11 is already affixed to their respective extension cords before use, and is fastened around the plug and socket once the two pieces are connected for power. The housing 11 fits snugly around the socket and plug preventing any separation between the plug and socket, so that that if either extension cords 40, 50 are pulled the housing 11 is strained rather that the plug and socket separating. Since the first portion 12 and the second portion 14 are threaded together, they are locked around the plug and socket to keep this union secure until the user decides to separate the two.

FIG. 3 depicts a perspective view of an alternative embodiment of the cord lock 10. In this alternative embodiment cord lock 10 includes beveled edges for a first portion 22 and a second portion 24. The first portion 22 and second portion 24 connect to each other similar to the first embodiment depicted in FIGS. 1 and 2. Each portion is affixed to the respective extension cords and protect the plug also in FIG. 1. Sectional views of the alternative embodiment are provided in FIG. 4. These sectional views show an opening within each respective portion to allow for the insertion of each respective cord, cord 40 and a cord 50. Once the portions are fastened together the portions 22, 24 protect the connection made between the plug 52 and socket 42 provided on each respective cord.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A cord lock comprising:
a. a housing, where the housing is fastened snugly around a plug of a first extension cord and a socket of a second extension cord;
b. a first portion of the housing, where the first portion includes a neck; and
c. a second portion of the housing, where the second portion includes a receiving portion to accept the neck of the first portion.

2. The cord lock according to claim 1, where the housing in cylindrical.

3. The cord lock according to claim 1, where the neck is threaded and where the receiving portion is threaded to enable the neck to screw into the receiving portion to fasten the first portion to the second portion.

4. The cord lock according to claim 1, where the neck includes a single thread and where the receiving portion includes a single thread to snap the neck into the receiving portion.
